(19) United States
(12) Patent Application Publication
(10) Pub. No.: US 2009/0158336 A1
(43) Pub. Date: Jun. 18, 2009

(54) Content Retrieval System

(75) Inventors: Jeffrey Newdeck, Plymouth Meeting, PA (US); Edmund Choromanski, Warrington, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/955,092

(22) Filed: Dec. 12, 2007

(51) Int. Cl. G06F 3/00

(52) U.S. Cl. 725/44

(57) ABSTRACT

A method of restoring electronic program guide metadata following the replacement of a previous electronic program guide application with a new electronic guide application includes recording a program and program identifying information, cross referencing program identifying information with raw electronic program listings to extract corresponding program metadata, and associating the corresponding program metadata with the recorded program such that the metadata can be displayed and used by the new electronic guide application. A system for restoring metadata associated with recorded programs includes a content record containing program identifying information, a listing containing archived metadata, and an indexing processor to extract metadata corresponding to said content record.

### BACKGROUND

A set-top box is a device that connects an audiovisual display with an external signal source. For example, a set-top box may be used for tuning or decoding a particular channel from a cable or satellite television signal for use by a home entertainment system. The external signal source may include, for example, a satellite dish, a coaxial cable, an Ethernet cable, a telephone line (including digital subscriber line connections), broadband over power line or a terrestrial television antenna. Content, in this context, could mean any or all of video, audio, or audiovisual content, including television programming, Internet web pages, interactive computer games, or other possibilities.

Set-top box manufacturers typically design and construct the set-top box hardware as well as the firmware that controls the basic functionality of the set-top box. Multiple service operators (MSOs) then purchase the set-top box and load a software package that may include a graphical viewer interface, electronic program guide (EPG) application, media player and other higher level programming.

The hardware, firmware and software work together to create various set-top box functionalities. For example, the set-top box hardware may receive a command from a remote control unit, which is then interpreted and formatted by the firmware. The firmware then passes the command to the service provider software package. The software package may respond by instructing the firmware to access a specific location in the set-top box memory, change data sources, display specific data or other functions.

The electronic program guide (EPG), also known as an interactive program guide or an electronic service guide, is an application that is typically created by a third party vendor and, as indicated above, is part of the programming installed on the set-top box after manufacture by a service provider who is deploying the set-top box. Typically, an EPG application includes a graphical user interface that enables the display of program titles, descriptive information such as a synopsis, actors, year of release and other descriptive metadata. This information is typically displayed on a grid with the option to select more information on each program. The EPG application enables a viewer to navigate through, and select, available content by time, title, channel, genre, etc., typically by using a remote control unit, a keyboard, or other user input device to control the EPG. The EPG application can also display the future schedule of programs offered by the service provider and other associated metadata that allows the viewer to make informed viewing choices. Audio or Radio EPG applications offer more text based displays of program name, program description, genre, on air or off-air, series, artist, album and track title information.

When an EPG application is used in connection with a digital video recorder (DVR) or personal video recorder (PVR), the EPG application may allow the viewer to schedule the recording of future programs and to view information associated with previously recorded programs. In many instances, set-top boxes have a built-in DVR or can be connected to an external recorder. The set-top box can then record data from a variety of sources and later retrieve this data for playback. This recording capability enables a variety of high level functions including time shifting, pause, rewind, and replay of the programming.

As indicated above, data can be transmitted in a variety of ways to the set-top box including cable television, satellite television, cable radio, satellite radio, or via terrestrial broadcast radio and television stations. Metadata that describes the content and is designed to be viewed through an electronic program guide (EPG) is typically sent within the broadcast transport stream or alongside it in a special data channel. The ATSC (Advanced Television Systems Committee) standard for digital television (DTV) uses tables sent in each station's PSIP (Program and System Information Protocol) to convey program metadata. These tables are meant to contain the program start time, title, and additional program-descriptive metadata.

Alternatively, some systems rely on third party “program listing aggregators” to provide quality EPG metadata content. Newer set-top boxes and DVRs may use an internet feed to download programming metadata that is used by and displayed in the EPG. This enables two-way interactivity for the viewer so that media download can be requested via the EPG or through a related link. This two-way interactivity may also allow the service provider to remotely program and diagnose set-top box features.

When a digital video recording of an audiovisual program is made, usually using the EPG as part of the set-top box or recorder's user interface as described above, the corresponding metadata is typically stored in a particular format that is specific to that EPG application. This metadata in that specific format is then used for partitioning the recorder's memory, indexing and accessing recorded programs through various set-top box applications. If the service provider or viewer replaces the current EPG application with a new vendor's EPG application, the new EPG application may be unable to interpret the format of the recorded metadata, thereby rendering the viewer's previous recordings useless.

This ties the service provider to whatever EPG vendor's product was initially deployed with that provider's DVR set-top boxes. It is desirable that the MSOs be able to change EPG vendors without risking customer dissatisfaction from the loss of recorded programs.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is an illustrative diagram of an exemplary system for data delivery to a set-top box, according to principles described herein.

FIG. 2 is an illustrative flowchart showing one embodiment of a data path of electronic program guide information, according to principles described herein.

FIG. 3 is an illustrative diagram of one embodiment of data flow during the recording of programming by a set-top box digital video recorder, according to principles described herein.

FIG. 4 is an illustrative diagram of one embodiment of an electronic program guide configured to display metadata associated with recorded programs, according to principles described herein.

FIG. 5 is an illustrative diagram of one embodiment of a method for restoring electronic program guide metadata, according to principles described herein.

FIG. 6 is an illustrative flowchart showing one embodiment of a method for restoring electronic program guide metadata, according to principles described herein.

Throughout the drawings, identical reference numbers designate similar, but not necessarily identical, elements.

### DETAILED DESCRIPTION

A content retrieval system described below provides for the restoration of metadata associated with recordings made by a set-top box digital video recorder (DVR) or similar device. As described above, when a DVR capable set-top box makes a DVR recording, the metadata which identifies the program (e.g., program title, length, actors, story summary, etc.) is stored by the electronic program guide (EPG) application that is executing on the set-top box at the time of the recording. This data is stored in a specific, often proprietary, format, and is not accessible to the end-user without the same vendor's EPG application executing on the set-top. If a service provider desires to replace the current EPG application being used on set-top boxes within their network with a different vendor's EPG application, their customers with DVR-capable set-top boxes will likely lose access to their recorded programs. This ties the service provider and viewers to whatever EPG application is initially installed on the DVR set-top boxes.

This situation can be addressed as described in the following specification. As detailed below, the service provider maintains databases that include raw program listing data and program metadata for all the programming provided. This information can be used to identify a recording on a set-top box and reformat the metadata associated with that recording to meet the needs of a new EPG application being deployed. For example, if and when an EPG application used by the set-top box population on the service provider's network is to be changed, the individual set-top boxes are prompted to transmit to the service provider information for each recording stored on or accessible to that set-top box, including, for example, the recording start time, recording end time, and source identification (ID) from each content record on that box. The service provider cross-references the content record with the raw program listing database to identify the program recorded and retrieves the associated metadata from a guide data archive database. If necessary, the metadata can then be manipulated into a format that is compatible with a new EPG application. The reformatted metadata is then transmitted back to the set-top box. The set-top box then receives and stores the new metadata for the recorded programming in the appropriate location, allowing the viewer to view and/or access recorded programs in the set-top box via the new EPG application when installed.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Throughout the specification and appended claims, the term “set-top box” is used to describe any hardware or software device that is configured to manage audio, video or audiovisual content from one or more sources for use with a television set, monitor, computer or other content playback device. Typically, a set-top box will be capable of interconnectivity with external devices and/or networks. In a basic embodiment, a set-top box will manipulate and display a plurality of channels of audiovisual programming received, for example, from a cable or satellite television network. However, many set-top box embodiments will have functionality that extends beyond basic channel management as described herein.

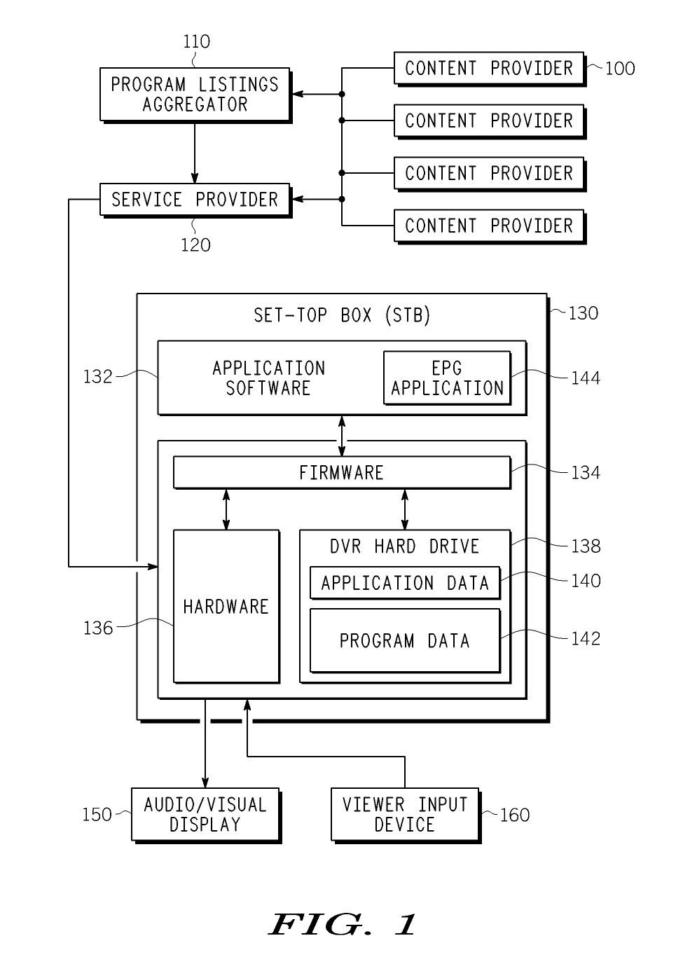

FIG. 1 is an illustrative diagram of an exemplary system for data delivery to a set-top box (130) by a service provider (120). The program content is first created by content providers (100). The content providers (100) then transmit the program content to the service provider (120). Metadata describing the content may also be available directly from the content providers (100) to the service provider (120).

The content providers (100) may also transmit program metadata to a program listings aggregator (110). The program listings aggregator (110) combines the listings obtained from the content providers (100) and may add additional information such as story summaries, ratings, actors, director, etc, that can be extracted from other sources of program information. The program listings aggregator (110) then passes the combined information to the service provider (120) as raw program listings. The service provider (120) can then reformat the raw program listings to create program metadata that matches the program schedule, channel organization and specific programs offered by that service provider (120). The program metadata from the raw program listings is also encoded in a specific format that is used by the EPG application (144) that runs on the set-top boxes deployed by that service provider (120). The service provider (120) then transmits the reformatted program information through its network to the population of subscriber set-top boxes (e.g., 130).

Set-top boxes (130) are typically placed within each subscriber's home or office and are connected to the audiovisual display system used by that subscriber. The set-top box (130) receives data from the service provider (120) and converts the data into audiovisual content, EPG listings, etc.

As described above, the set-top box components provided by the set-top box manufacturer are integrated and include, for example, the hardware (136), including perhaps a DVR hard drive (138), and firmware (134) which controls the low-level functionality of the hardware (136, 138). However, it should be noted that the DVR hard drive (138) is not necessarily a component internal to the set-top box (130), but could also be an external hard drive or a hard drive in another unit accessible to the set-top box (130).

The service provider (120) typically purchases the set-top box (130) from the set-top box manufacturer and installs application software (132). These applications (132) control the high-level functionality and interact with the firmware (134), which in turn controls the hardware (136, 138). The application software (132) may include a variety of different modules including an EPG application (144).

Typically, these applications (132) access information contained within an application data partition (140) of the hard drive (138), while a separate program data partition (142) is reserved for access by the firmware (134). The set-top box (130) interacts with the viewer by transmitting audio and visual data to the viewer through the audiovisual display device (150) and receiving viewer input through a user interface or input device (160).

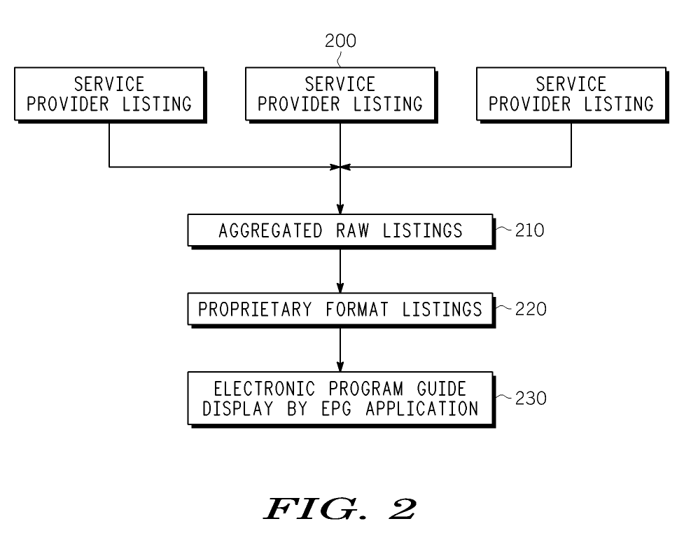

FIG. 2 is an illustrative flowchart showing one embodiment of an EPG metadata path. The audiovisual programs are initially generated by content providers (100, FIG. 1). Examples of content providers (100, FIG. 1) are the National Broadcasting Company (NBC) or the British Broadcasting Company (BBC), which create audiovisual programs designed to be distributed to viewers. The content providers (100, FIG. 1) also generate descriptive metadata associated with these programs. This descriptive metadata is formatted into service provider listings (200) and transmitted to service providers and, in some cases, a program listings aggregator (110, FIG. 1). The service provider listing (200) may consist of a variety of data associated with each program created by the content provider (100, FIG. 1). This information may include the genre, series name, the episode title, the content provider name, the length of the program or episode, a brief description of the subject matter of the program, the names of the actors or actresses, director, year of release, etc.

Various service provider listings (200) are assembled by the program listings aggregator (110, FIG. 1). For example, TV Guide™ is a commonly known program listings aggregator. The program listings aggregator (110, FIG. 1) may add additional information such as rating, reviews, story summaries, teasers, biographies, photographs of actors/actresses, and screen shots to produce aggregated raw listings (210). The aggregated raw listings (210) are then available to or transmitted to the service provider (120, FIG. 1). The server provider (120, FIG. 1) formats the aggregated raw listings (210) to conform to the program and channel line up that will be distributed to the provider's subscribers. This includes adding scheduling information such as the day and time the program will be broadcast and the channel over which the program will be transmitted. Additionally, the raw listings are converted into a specific format required by the EPG application that currently resides on the set-top boxes used by that service provider.

The formatted and supplemented listings are then transmitted as proprietary format listings (220) containing the EPG metadata. The proprietary format listings (220) are received by the individual set-top boxes (130, FIG. 1) within the service provider's network. The resident EPG application on the set-top box (130, FIG. 1) displays the EPG including the program metadata as requested by the viewer, allowing the viewer to determine which programs they would like to view or record from the offerings provided by the service provider (120, FIG. 1). As mentioned above and discussed in more detail below, the EPG application stores the metadata on a separate partition of the DVR hard drive (138, FIG. 1) called the application partition (140, FIG. 1).

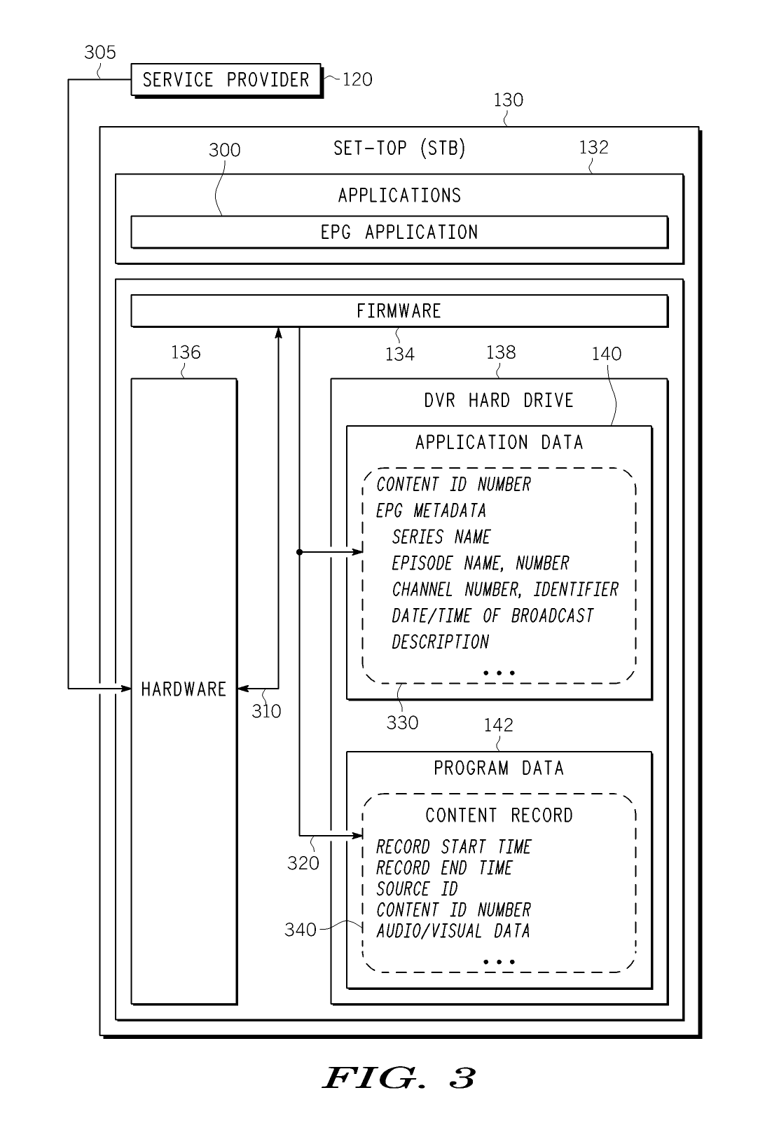

FIG. 3 is an illustrative diagram of one embodiment of data flow during the recording of programming by a set-top box DVR. Viewers may have a variety of reasons for wanting to record programs, including time shifting or archiving favorite shows. FIG. 3 illustrates one possible method by which the set-top box (130) might record a program of interest for the viewer. The data stream (305) from the service provider (120) is initially received by the hardware (136), which transmits the data to the firmware (134) through a data path (310). The data stream may include audiovisual content and EPG metadata, as well as other content that the service provider (120) may wish for the set-top box (130) to receive. The firmware (134) can perform a variety of operations on the incoming data stream. These operations may include decoding data, separating the data stream into various components, decryption, formatting the audiovisual data for display and other functions. If a recording is to be made, the firmware (134) then transmits the data stream to the DVR hard drive (138) for recording.

Recording of a specific program can begin when a viewer directly or indirectly initiates the recording process or when a scheduled recording event occurs. The firmware creates a content record (340) in response to the instruction to begin recording. The content record is recorded on the program data partition (142) of the DVR hard drive (138). The content record (340) contains additional information that is not tied to a specific EPG vendor and can be accessed through the firmware without using an EPG application. This additional information could include a global positioning system (GPS) recording start time, the GPS recording end time, source ID and content ID number. Because programs are broadcast at different times in different time zones, GPS may be used to determine the location or time zone a particular set-top box so that this information can be used to identify a specific broadcast or program content in the corresponding content record. This information could be used to identify each of the recorded programs. These data fields, in addition to the audiovisual data, comprise the content record (340) which is created for each recorded program.

The source ID is an integer value which uniquely identifies a particular service or programming source. This value is used by the set-top box to associate and display the correct EPG metadata to the viewer. For example, the source ID for Home Box Office (HBO) East is used to associate the channel to which the viewer must tune (i.e. channel 201) with the correct EPG data for HBO East. The channel tuned may be different in different areas, but the EPG metadata for this source ID will be the same for all viewers.

As indicated, EPG metadata (330) is recorded in the application partition (140) of the DVR hard drive (138). The EPG metadata (330) can include the series name, the episode name/number, the channel number, the network identifier, the date/time of the broadcast, the description of the contents, etc. In addition to the metadata received from the service provider, a content ID number is assigned to the EPG metadata (330). This content ID is a unique identifier of the recording event which enables the EPG application to associate the EPG metadata (330) with the corresponding content record (340). The content ID is a data tag that allows the EPG application (300) to specifically identify a content record when interfacing with the firmware (134). As shown in FIG. 3, the content ID may be included in both the EPG metadata (330) of the application data (140) and the content record (340) of the program data (142).

As previously discussed, the EPG metadata (330) is in a specific or proprietary format that cannot be readily accessed without using the EPG application that created it. When the viewer wants to browse or view programs they have recorded, the viewer starts the EPG application (300) which displays the recorded programming metadata in a graphical user interface format.

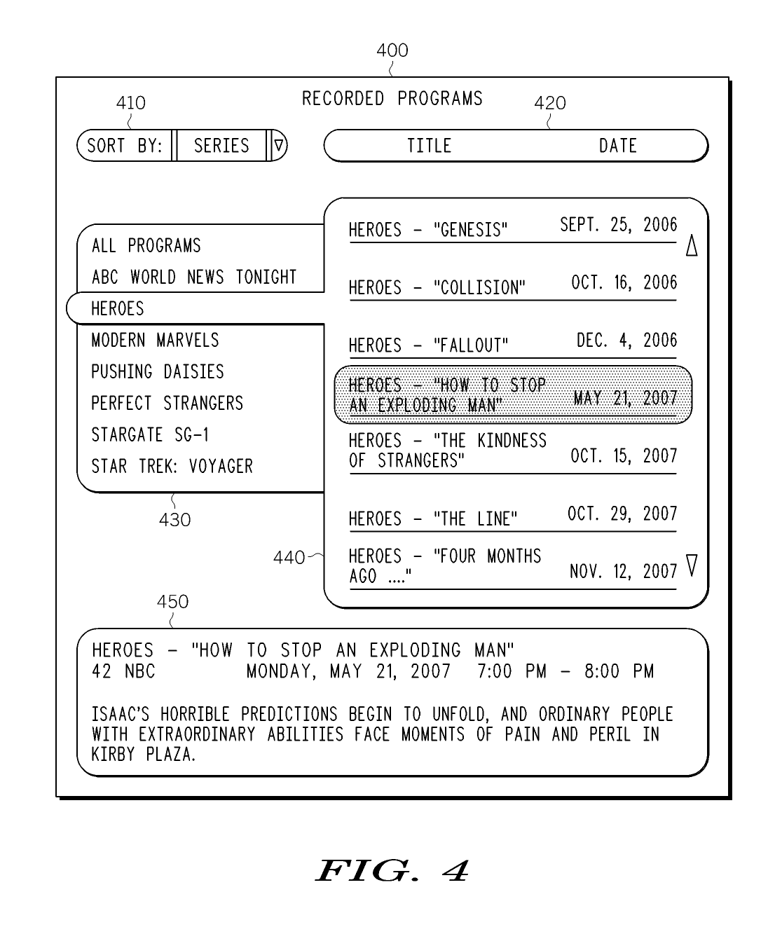

FIG. 4 is an illustrative diagram of one embodiment of an EPG application displaying metadata from recorded programs in a graphical user interface format (400). The graphical user interface (400) can contain a variety of fields, including a “sort by” field (410) which allows the viewer to select how the recorded programs will be presented. For example, the viewer may want to list the recorded programs in order of recording date. This would allow the viewer to easily select the last recorded program or to identify another program by the recording date. If the viewer knows the name of the program they wish to watch, the viewer may wish to display the list in alphabetical order. To change the method by which the recorded programs are listed the viewer can press an arrow in the “sort by” field (410) and select from a drop-down menu the option that would most easily allow him or her to select the desired program. In FIG. 4, the “sort by” option has been set to display the metadata by series. This instructs the EPG application to organize the presentation of metadata by grouping the recorded programs into their respective television series names. The categorized listing (430) may display the series groups in alphabetical order. For example, the categorized listing shows that the viewer has recorded episodes from the series “Heroes,” “Perfect Strangers,” “Stargate SG—1,” and others.

In this example, the viewer has selected the series “Heroes” from the categorized listing (430). To the right of the categorized listing (430) is an episode listing (440). The episode listing (440) shows each episode title that was recorded from the selected series. Additional metadata is displayed when an individual episode is selected from the episode listing (440). For example, “Heroes—How to Stop an Exploding Man” is highlighted in the episode listing (440). A detailed view (450) then shows additional metadata about this particular episode. The additional metadata includes the series name, the episode title, the channel number on which this episode was broadcast, the call letters of the channel, the date and time which the episode was originally broadcast and a brief description of the content within the episode.

Without the display of program identifying metadata, it can be very difficult for the viewer to select and access recorded programs. As discussed above, the metadata displayed by the EPG application is stored in a specific or proprietary format and is not accessible to the end viewer without the same vendor's EPG application executing on the set-top. If the service provider wishes to migrate the set-top boxes within their network to a different vendor's EPG application, all of the subscribers with DVR set-top boxes could lose access to their recorded programs. This ties the MSOs to whatever EPG vendor's application they originally deployed on the set-top boxes. Being restricted to a single vendor's application can be undesirable for a variety of reasons including economic, competitive, service or other value driven considerations.

One method of migrating the recorded metadata from a first EPG vendor's format to a second EPG vendor's format is to create a translator application. The translator application is created by obtaining the proprietary format used by the first EPG vendor and creating a mapping algorithm that translates the first format into the second EPG vendor's format. This approach has a variety of drawbacks including lack of motivation for the first EPG vendor to provide the proprietary format information so that a competitor's application can be installed. If the first EPG vendor refuses to cooperate, the translator application can still be created. However, issues of reverse engineering costs, contract terms, unauthorized use of proprietary information, etc. can create high costs. It is extremely desirable to be able to re-create the metadata required to accurately display metadata associated with customer recordings in the EPG without requiring the use of third party proprietary information.

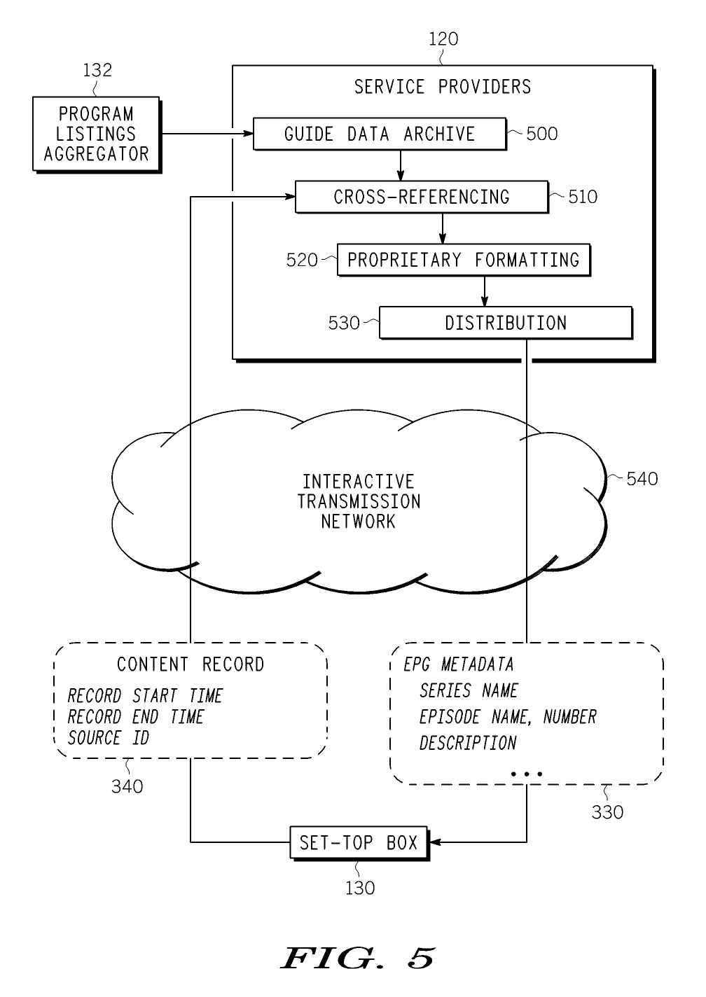

FIG. 5 illustrates a diagram showing one embodiment of a method for restoring EPG metadata that is associated with recorded programs. According to this exemplary method, the program listings aggregator (132) sends the raw program listings to the MSOs, including specific service providers (120).

The service provider (120) archives the raw programs listing in a guide data archive server (500). When the service provider (120) desires to change EPG application vendors, the archived data can be cross referenced to set-top box data using information contained in the content record (340). The set-top box could transmit the content record (340) including the record start time, the record end time and the source ID number through an interactive transmission network (540) to the service provider (120).

The service provider (120) uses the source ID to identify the unique service provider channel that originally provided the recorded data. The record start time and the record end time can then be used to identify the specific programming that occurred within the recording window on the service provider channel. The archived raw metadata can then be found for that program from the guide data archive server (500).

If necessary, the raw metadata can then be formatted to be compatible with the new EPG vendor's software application. This formatting could be performed by the service provider (120) or the raw program listings could be sent to the new EPG vendor for formatting. Formatting the raw metadata creates EPG compatible metadata (330) for the new EPG to be deployed. The EPG compatible metadata (330) can then be distributed (530) to the individual viewers through the interactive transmission network (540).

The set-top box (130) records the EPG compatible metadata (330) in the application partition (140, FIG. 3) of the DVR hard drive (138) under the correct content ID number. The new EPG application can then accurately display the EPG compatible metadata and access the recorded programs.

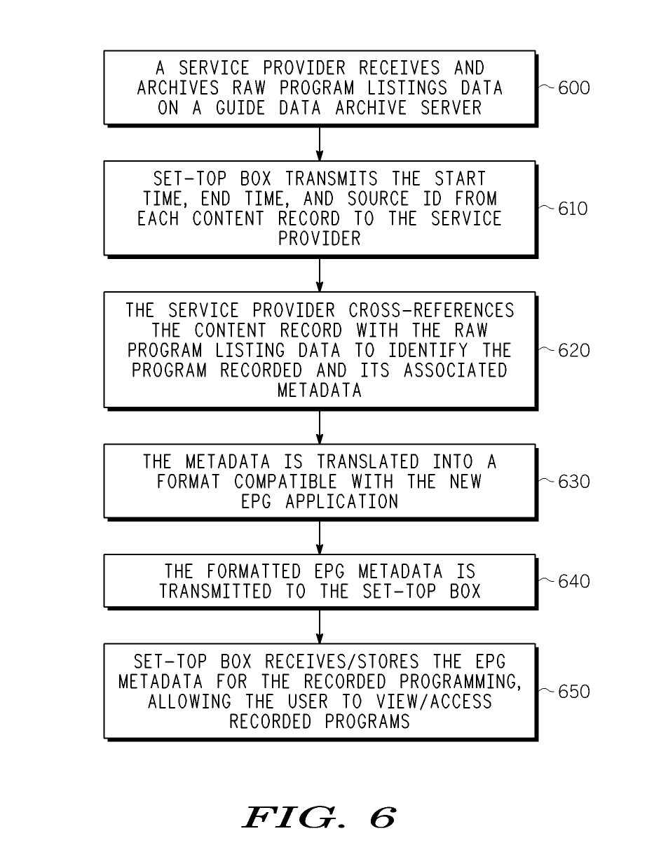

FIG. 6 is an illustrative flowchart showing one embodiment of a method for restoring EPG metadata. According to this exemplary method, the service provider receives and archives raw program listings data from the program listings aggregator on a guide data archive server (step 600).

If and when an EPG application used by the set-top box population on the service provider's network is to be changed, the individual set-top boxes are prompted to transmit the recording start time, recording end time, and source ID from each content record on that box to the service provider (step 610). The service provider cross-references the content record with the raw programs listing data to identify the program recorded and retrieves the associated metadata from the guide data archive server (step 620). If necessary, the metadata can then be manipulated into a format that is compatible with the new EPG application (step 630). The reformatted metadata is then transmitted to the set-top box (step 640). The set-top box then receives and stores the new metadata for the recorded programming in the appropriate location, allowing the viewer to view and/or access recorded programs in the set-top box via the new EPG application (step 650) when installed.

According to an alternative embodiment, the set-top box does not transmit the content records to the service provider. Instead, the service provider uses the archived raw listings to create a comprehensive revised raw listing and distributes it to all the set-top boxes. Additionally, the service provider creates a cross-referencing application and distributes it to all the set-top boxes. The cross-referencing application performs the necessary functions of looking up and indexing to find the corresponding metadata for each content record. If necessary, the cross-referencing application could also perform formatting functions to create EPG compatible metadata. The set-top box opens the cross-referencing application and finds the corresponding metadata within the comprehensive raw listing using the content records. The corresponding metadata then replaces the proprietary metadata used by the previous EPG application on the application partition.

By archiving the raw program listings data and using the content record data to identify the corresponding metadata for each content record, the metadata associated with recorded programs can be revised or reformatted. This allows the recorded content on a DVR set-top box to become EPG application independent, and the service provider or viewer is free to change EPG applications without the risk of losing access to the recorded programs.

The process shown in FIG. 6 and the other figures of this application may be implemented in a general, multi-purpose or single purpose processor. Such a processor will execute instructions, either at the assembly, compiled or machine-level, to perform that process. Those instructions can be written by one of ordinary skill in the art following the description of FIG. 6 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method of restoring electronic program guide metadata following the replacement of a previous electronic program guide application with a new electronic guide application comprising:
cross-referencing program identifying information for a recorded program with raw electronic program listings to identify corresponding program metadata; and
formatting said corresponding program metadata for said recorded program such that said corresponding program metadata may be displayed and used to access said recorded program through said new electronic guide application.

2. The method of claim 1, further comprising the step of receiving and archiving said raw electronic program listings containing program metadata.

3. The method of claim 2, wherein said step of receiving and archiving said raw electronic program listings is performed by an external provider on a guide data archive server.

4. The method of claim 2, wherein said step of recording a program and program identifying information is performed by a set-top box.

5. The method of claim 4, wherein said archived raw programs listings are transmitted to said set-top box, and said cross-referencing occurs within said set-top box.

6. The method of claim 4, further comprising the step of transmitting said program identifying information from said set-top box to said external provider.

7. The method of claim 6, wherein said program identifying information includes a recording start time, a recording stop time, and a source identification.

8. The method of claim 7, wherein said step of cross-referencing further comprises using said recording start time, said recording stop time, and said source identification to identify a recorded program and said corresponding program metadata.

9. The method of claim 8, further comprising the step of formatting said corresponding program metadata such that said corresponding program metadata is compatible with said new electronic program guide application.

10. The method of claim 9, further comprising the step of transmitting said corresponding program metadata to said set-top box.

11. The method of claim 10, wherein said corresponding program metadata is displayed on an electronic program guide application such that a viewer can view and access said recorded programs through said electronic program guide application.

12. A system for restoring metadata associated with recorded programs comprising:
a recorded program;
a content record associated with said recorded program, said content record comprising program identifying information;
a listing containing archived metadata;
an indexing processor configured to use said program identifying information to extract metadata corresponding to said recorded program from said list.

13. The system of claim 12, wherein said recorded program and said content record are recorded on a hard drive of a set-top box.

14. The system of claim 13, wherein said content record comprises a recording start time, a recording end time, and a source identification.

15. The system of claim 14, wherein said listing is stored on a guide data archive server by an external provider.

16. The system of claim 15, further comprising an interactive transmission network; said interactive transmission network configured to transmit data between said set-top box and said external provider.

17. The system of claim 16, wherein said set-top box transmits portions of said content record via said interactive transmission network to said external provider.

18. The system of claim 17, wherein said external provider cross references said portions of said content record with said listing to extract corresponding metadata associated with said recorded program.

19. The system of claim 18, wherein said corresponding metadata is configured for display on an electronic program guide.

20. The system of claim 19, wherein said electronic program guide displays said corresponding metadata such that a viewer can select and access said recorded program.
